(19) United States
(12) Patent Application Publication
(10) Pub. No.: US 2009/0046044 A1
(43) Pub. Date: Feb. 19, 2009

(54) APPARATUS FOR DRIVING A DISPLAY PANEL

(75) Inventor: Chien-Chun CHEN, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Tainan County (TW)

(21) Appl. No.: 11/838,806

(22) Filed: Aug. 14, 2007

(51) Int. Cl. G09G 3/36

(52) U.S. Cl. 345/87

(57) ABSTRACT

A source driver including a first line buffer, a second line buffer, a third line buffer and an analog-to-digital converter is provided. The first line buffer sequentially latches first data bits of values of pixels. The second line buffer sequentially latches second data bits of the values of the pixels. The third line buffer parallelly transfers all the data bits latched by the first and second line buffers. The analog-to-digital converter generates driving voltages for the pixels according to the first and second data bits transferred by the third line buffer, in which the first and second line buffers operate in parallel.

### BACKGROUND

1. Field of Invention

The present invention relates to an apparatus for driving a display panel. More particularly, the present invention relates to a source driver capable of driving a display panel at a higher frame rate than conventional source drivers.

2. Description of Related Art

Liquid Crystal Display is a display device using the characteristics of liquid crystals to achieve the displaying effect. A source driver is for receiving digital frame signals from a timing controller (TCON) and converting them into analog voltage signals to transfer frame signals to the display. Refer to FIG. 1, illustrating a conventional driving apparatus for a display. Digital frame data provided by the TCON is inputted to a line buffer 102 according to a clock signal (CLK) with a pre-determined clock frequency (i.e. 60 Hz). The line buffer 102 then outputs the digital frame data, which are data bits of values of pixel, to a digital-to-analog converter 104.

In order to prevent flickers and traces from happening, traditional display panels display frames at a refresh rate of 50˜60 Hz. Since the response time of the display panel is decreasing, display panels, which refresh at 120 Hz are starting to appear. The source drivers for such display panels must be able to process frame signals at 120 Hz. However, raising the operating frequency of the driving apparatus from 50˜60 Hz up to 120 Hz causes many problems to arise, such as electromagnetic interference, high power dissipation etc. . . .

For the forgoing reasons, there is a need for a new apparatus for driving a display panel at a higher frame rate (i.e. 120 Hz). For example, if the conventional source driver is capable of outputting 160 data bits of values of pixels per frame at a clock frequency of 120 Hz, the new source driver will need to process the same amount of bits at the original frequency of 60 Hz to avoid the problems mentioned above.

### SUMMARY

The embodiments of the present invention is directed to a source driver, that it satisfies this need of increasing the data throughput without raising the clock frequency. One embodiment of the present invention is a source driver, which includes a first line buffer, a second line buffer, a third line buffer and an analog-to-digital converter. The first line buffer sequentially latches first data bits of values of pixels. The second line buffer sequentially latches second data bits of the values of the pixels. The third line buffer parallelly transfers all the data bits latched by the first and second line buffers. The analog-to-digital converter generates driving voltages for the pixels according to the first and second data bits transferred by the third line buffer, in which the first and second line buffers operate in parallel.

Furthermore, the first and second line buffers include shift registers controlled by multiplexers to trigger the latching of data bits at the first and second line buffers. The shift registers send trigger signals simultaneously to the first and second line buffers so that the data bits of values of pixels are latched in parallel.

Therefore, the first and second line buffers may be viewed as front line buffers each sequentially latching data bits of values of pixels. The third line buffer may be viewed as a post line buffer parallelly transferring all the data bits latched by the front line buffers. Thus, the analog-to-digital converter is to generate driving voltages for the pixels according to the data bits transferred by the post line buffer.

From the above embodiments, the data bits of values of pixels are latched in parallel, thus doubling the number of bits latched per clock cycle. Thus the source driver can transfer bits of values of pixels at a frame rate of 120 Hz while clocking at 60 Hz.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of a conventional driving apparatus for a display; and

FIG. 2 is a block diagram of a source driver structure according to a first embodiment of the present invention.

FIG. 3 is a block diagram of the source driver structure according to a second embodiment of the present invention.

FIG. 4 is a block diagram of the source driver structure according to a third embodiment of the present invention.

FIG. 5 is a block diagram of the source driver structure according to a fourth embodiment of the present invention.

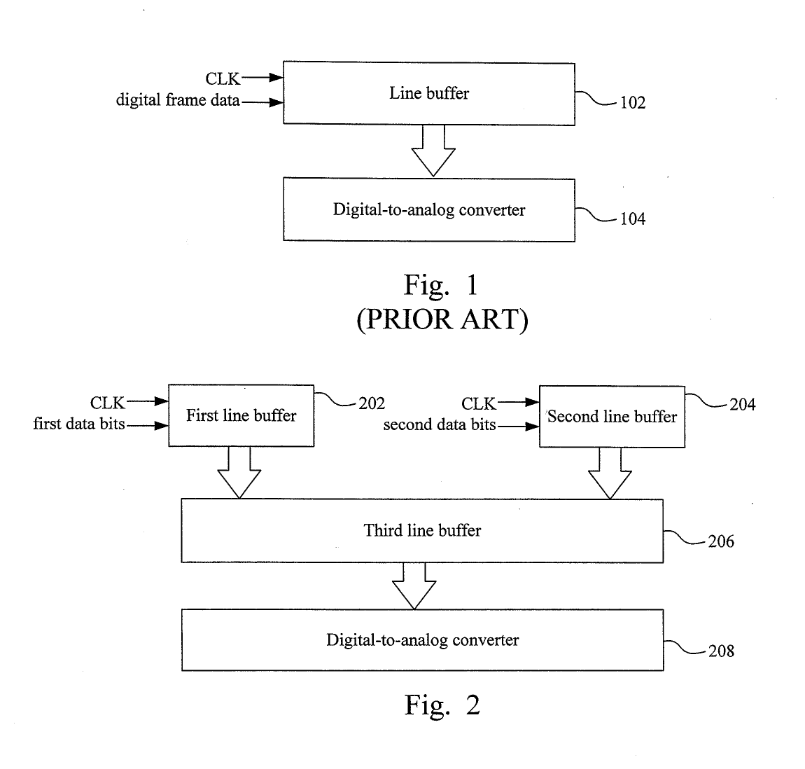

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The embodiments of the present invention assumes a source driver is used to transfer 160 bits of values of pixels where the first 80 bits are referred to as A0-A79, and the last 80 bits are referred to as B0-B12. The clock is operating at 60 Hz, the data bits are to be transferred to the digital-to-analog converter (DAC) in alternating arrangements. For example, the data bits are transferred to the DAC in the arrangement of A0 A1 B0 B1 A2 A3 B2 B3 . . . or, when the pixels are in the swap mode, in the arrangement of B79 B78 A79 A78 B77 B76 A77 A76 . . . .

Please refer to FIG. 2, a block diagram of a source driver structure according to a first embodiment of the present invention. The source driver includes a first line buffer 202, a second line buffer 204, a third line buffer 206 and a digital-to-analog converter 208. The first line buffer 202 is used to sequentially latch first data bits of values of pixels A0-A79. Meanwhile, the second line buffer 204 sequentially latches the second data bits of values of pixels B0-B79. The third line buffer 206 then parallelly transfers all the data bits latched by the first and second line buffers 202, 204. Therefore, since the first and second line buffers 202, 204 are almost simultaneously latching with a CLK signal frequency of 60 Hz and transferring to the third line buffer 206 in parallel; all 160 bits can be transferred in one 60 Hz clock cycle. From another perspective, 80 bits of data are being transferred at 120 Hz. Lastly, the digital-to-analog converter 208 generates driving voltages for the pixels according to the first and second data bits transferred by the third line buffer 206.

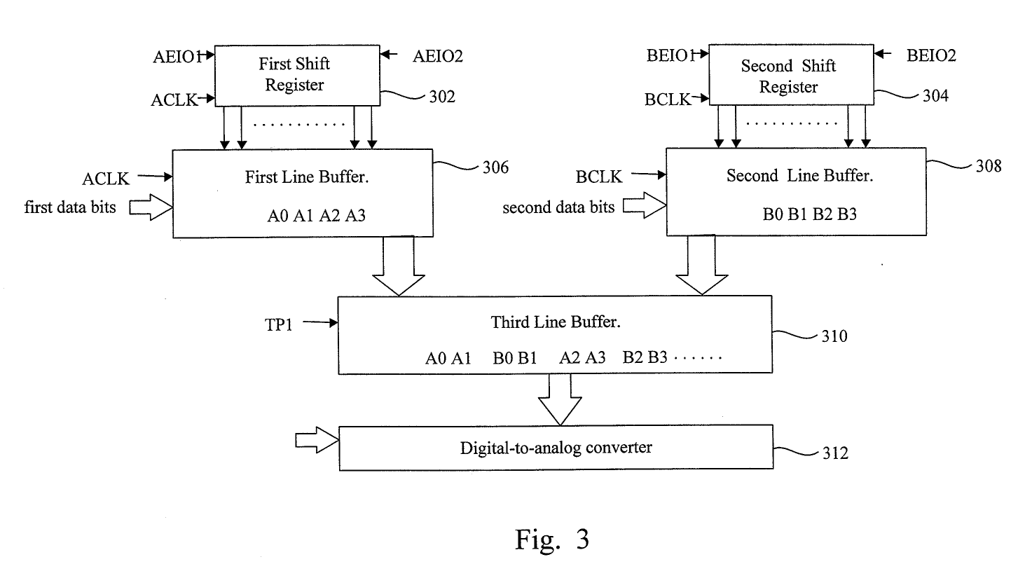

Please refer to FIG. 3, a block diagram of the source driver structure according to a second embodiment of the present invention. In this embodiment, the source driver further includes first shift registers 302 and second shift registers 304. The first shift registers 304 couples with the first line buffer 306 to sequentially write the first data bits (A0-A79) into the first line buffer 306. The first data bits are written according to a first clock signal (ACLK). The first shift register 302 may transfer trigger signals such as AEIO1 and AEIO2 to the first line buffer 306 according to ACLK, so that the trigger signals can trigger the latching of the first data bits. AEIO1 and AEIO2 signals may be 2 pairs of RSDS signals.

Similarly, second shift registers 304 couples with the second line buffer 308 to sequentially write the second data bits (B0-B79) into the second line buffer 308. The second data bits are written according to a second clock signal (BCLK). The second shift registers 308 may transfer trigger signals such as BEIO1 and BEIO2 to the second line buffer 304 according to BCLK, so that the trigger signals can trigger the latching of the second data bits.

At the same time, the first data bits and the second data bits are parallelly transferred from the first and second line buffers 306, 308 to the third line buffer 310. The arrangement of the data bits of values of pixels temperately stored in the third lien buffer 310 are determined by a control signal (TP1), which may alternately store the data bits latched by the first and second line buffer 306, 308 by one or more bits. For example, the data bits may be arranged as A0 A1 B0 B1 A2 A3 B2 B3 . . . in the third line buffer 310. The alternating arrangement may represent alternating insertion of frames such as impulsive frames into an image with a frame rate of 60 Hz. Lastly, the third line buffer 310 transfers all the data bits to a digital-to-analog converter 312 for further signal processing.

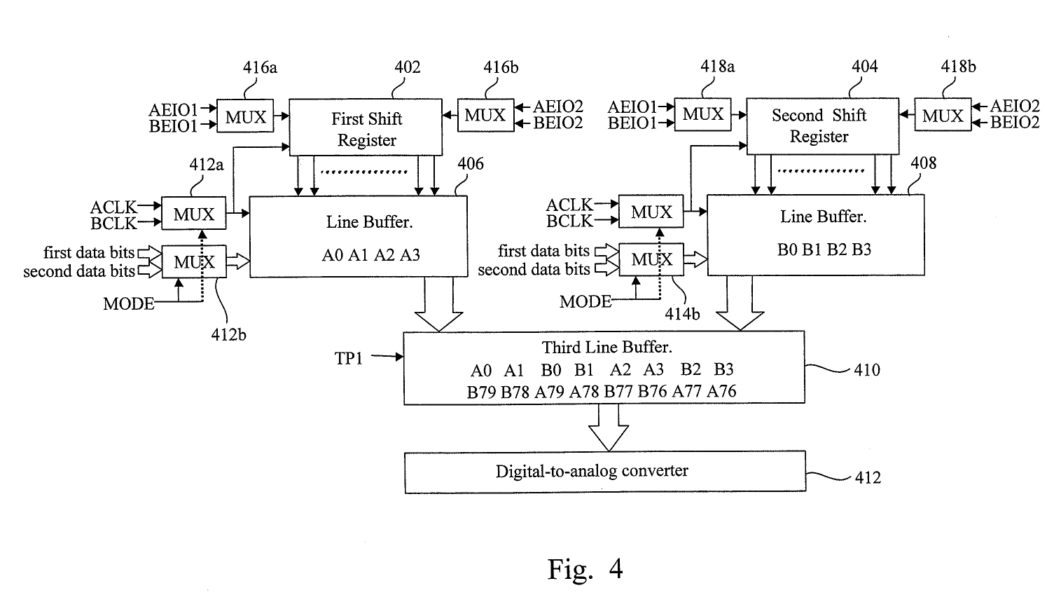

Please refer to FIG. 4, a block diagram of the source driver structure according to a third embodiment of the present invention. In this embodiment, the source driver supports the swapping function. The swapping function allows the data bits to be arranged from the rightmost alignment or from the leftmost alignment. For example, the data bits temperately stored in the third line buffer 410 can be arranged as A0 A1 B0 B1 A2 A3 B2 B3 . . . or as B79 B78 A79 A78 B77 B76 A77 A76 . . . depending on mode of operation (right or left mode). Therefore, to support the swapping function, the third embodiment of the present invention includes first multiplexers 412a, 412b and second multiplexers 414a, 414b. The first multiplexers 412a, 412b selects the first data bits and the first clock signal for the first line buffer 406 and the first shift registers 402. The second multiplexers 414a, 414b selects the second data bits and the second clock signal for the second line buffer 408 and the second shift registers 404. The first and second multiplexers 412a, 412b, 414a, 414b may be controlled by a mode signal. For example, if the source driver is in the right mode, the first line buffer 406 may be latching the data bits A0-A79, and the second line buffer 408 may be latching the data bits B0-B79, so that the data bits temperately stored in the third line buffer 410 are arranged as A0 A1 B0 B1 A2 A3 B2 B3 . . . . On the contrary, if the source driver is in the left mode, the first line buffer 406 may be latching the data bits B0-B79, so that the data bits temperately stored in the third line buffer 410 are arranged as B79 B78 A79 A78 B77 B76 A77 A76 . . . . The data bits stored in the third line buffer 410 is then transferred to the digital-to-analog converter 412, which generates driving voltages for the pixels.

The above mentioned alternating arrangement of data bits are merely examples, and does not intend to be limiting to the arrangement of data bits. Furthermore, the mode signal is not limited to left and right, thus any mode of operation controlling the data bits latched by the first and second line buffers 406, 408 are within the scope of the embodiments of the present invention.

In addition, a third and fourth multiplexers 416a, 416b, 418a, 418b along with the first and second multiplexers 412a, 414a are coupled to the first and second shift registers 402, 404, respectively, to control the trigger signals (ie. AEIO1, AEIO2, BEIO1, BEIO2), so that the first and second data bits are triggered according the operation mode of the source driver.

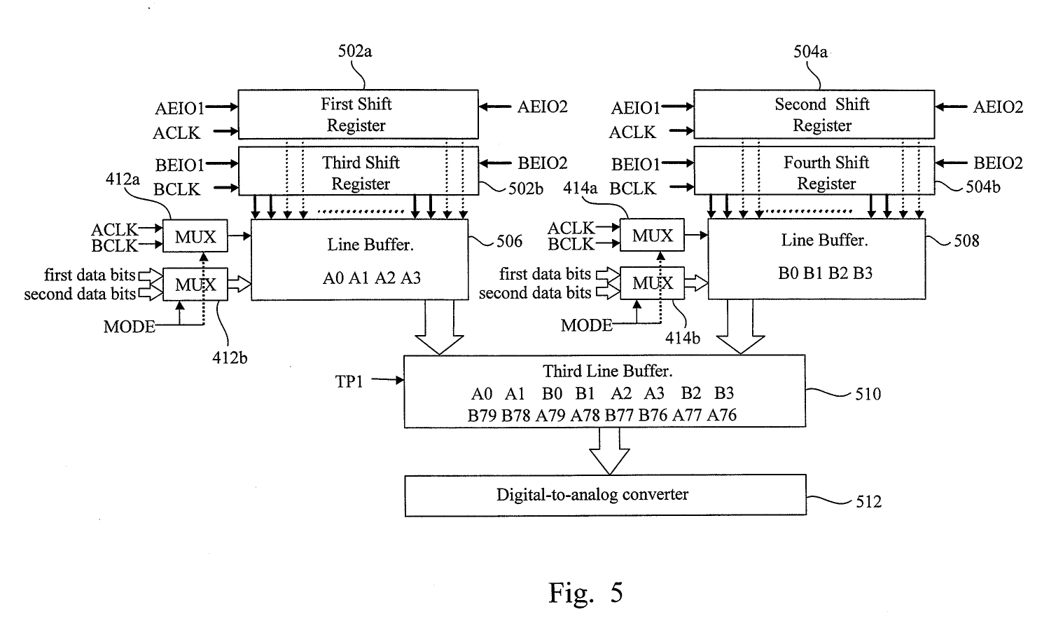

The use of multiplexers can occupy a significant amount of board space in the source driver design. Therefore, an alternate design accomplishing the same function may be implemented as in FIG. 5. In a fourth embodiment of the present invention, the source driver includes a plurality of first shift registers 502a, second shift registers 504a, third shift registers 502b, and fourth shift registers 504b. The first shift registers 502a may be arranged to sequentially write the first data bits into the first line buffer 506 according to a first clock signal (ACLK), and the third shift register 502b may be arranged to sequentially write the second data bits into the first line buffer 506 according to a second clock signal (BCLK). Similarly, the second shift register 502a may be arranged to sequentially write the second data bits into the second line buffer 508 according to the second clock signal (BCLK), and the fourth shift register 504b are arranged to sequentially write the first data bits into the second line buffer 508 according to the first clock signal (ACLK). Thus, each set of shift registers have corresponding group of data bits latched thereto. This structure eliminates the need for the third and fourth multiplexers 416a, 416b, 418a, 418b in the third embodiment of the present invention, while also parallel transfer the all the data bits parallelly to the third line buffer 510 and then to the digital-to-analog converter 512. Since the area occupied by shift registers are significantly less than the area occupied by the multiplexers, the source driver structure in the fourth embodiment of the present invention occupies less area than the source driver in the third embodiment of the present invention.

The source driver structure of the above mentioned embodiments may also be viewed as having a plurality of front line buffers (ie. first and second line buffers), where each front line buffer sequentially latches data bits of values of pixels and parallelly transferring all the data bits latched the front line buffers to a post line buffer (ie. third line buffer). A digital-to-analog converter then generates driving voltages for the pixels according to the data bits transferred by the post line buffer. By operating the front line buffers in parallel, the frame rate of the source driver may increase based on the number of front line buffers operating in parallel, while all the front line buffers are clocked at a clock frequency, which does not need to be increased with the increase in the number of front line buffers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver comprising:
a first line buffer sequentially latching first data bits of values of pixels;
a second line buffer sequentially latching second data bits of the values of the pixels;
a third line buffer parallelly transferring all the data bits latched by the first and second line buffers; and
an analog-to-digital converter generating driving voltages for the pixels according to the first and second data bits transferred by the third line buffer;
wherein the first and second line buffers operate in parallel.

2. The source driver as claimed in claim 1, further comprising:
a plurality of first shift registers coupling the first line buffer to sequentially write the first data bits into the first line buffer according to a first clock signal (ACLK); and
a plurality of second shift registers coupling second line buffer to sequentially write the second data bits into the second line buffer according to a second clock signal (BCLK).

3. The source driver as claimed in claim 2, further comprising:
a plurality of first multiplexers selecting the first data bits and the first clock signal for the first line buffer and the first shift registers; and
a plurality of second multiplexers selecting the second data bits and the second clock signal for the second line buffer and the second shift registers.

4. The source driver as claimed in claim 3, wherein the selections of the multiplexers are controlled by a mode signal.

5. The source driver as claimed in claim 1, further comprising:
a plurality of first shift registers and third shift registers coupling the first line buffer, wherein the first shift register are arranged to sequentially write the first data bits into the first line buffer according to a first clock signal (ACLK), and the third shift register are arranged to sequentially write the second data bits into the first line buffer according to a second clock signal (BCLK); and
a plurality of second shift registers and fourth shift registers coupling the second line buffer, wherein the second shift register are arranged to sequentially write the second data bits into the second line buffer according to the second clock signal (BCLK), and the fourth shift register are arranged to sequentially write the first data bits into the second line buffer according to the first clock signal (ACLK).

6. The source driver as claimed in claim 5, further comprising:
a plurality of first multiplexers selecting the first data bits and the first clock signal for the first line buffer such that the first data bits are latched by the first line buffer with the first shift registers; and
a plurality of second multiplexers selecting the second data bits and the second clock signal for the second line buffer such that the second data bits are latched by the second line buffer with the second shift registers.

7. The source driver as claimed in claim 6, wherein the selections of the multiplexers are controlled by a mode signal.

8. The source driver as claimed in claim 1, wherein all the data bits latched by the first and second line buffers are temporarily stored in the third line buffer.

9. The source driver as claimed in claim 8, wherein the arrangement of the data bits latched by the first and second line buffers are alternate stored in the third line buffer by one or more bits.

10. A source driver comprising:
a plurality of front line buffers each sequentially latching data bits of values of pixels;
a post line buffer parallelly transferring all the data bits latched by the front line buffers; and
an analog-to-digital converter generating driving voltages for the pixels according to the data bits transferred by the post line buffer;
wherein the front line buffers operate in parallel.

11. The source driver as claimed in claim 10, further comprising:
a plurality of shift registers respectively coupling the front line buffers to sequentially write the data bits into the corresponding front line buffers according to a plurality of clock signals.

12. The source driver as claimed in claim 11, further comprising:
a plurality of multiplexers selecting the corresponding data bits and clock signal for the front line buffers and the shift registers.

13. The source driver as claimed in claim 12, wherein the selections of the multiplexers are controlled by a mode signal.

14. The source driver as claimed in claim 12, wherein at least two of the shift registers are stacked to couple one of the front line buffers.

15. The source driver as claimed in claim 10, wherein all the data bits latched by the front line buffers are temporarily stored in the post line buffer.

16. The source driver as claimed in claim 15, wherein the arrangement of the data bits latched by the front line buffers are alternate stored in the post line buffer by one or more bits.
